(19) United States
(12) Patent Application Publication
(10) Pub. No.: US 2008/0136861 A1
(43) Pub. Date: Jun. 12, 2008

(54) METHOD AND APPARATUS FOR PRINTING CONDUCTIVE INKS

(75) Inventors: Michael Benton Free, St. Paul, MN (US); John S. Huizinga, White Bear Lake, MN (US); Rick L. Neby, Plymouth, MN (US); Daniel W. Hennen, Cottage Grove, MN (US); Gregory G. Jager, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/609,156

(22) Filed: Dec. 11, 2006

(51) Int. Cl. B41J 2/015

(52) U.S. Cl. 347/21

(57) ABSTRACT

A printer for digital printing in which conductive ink is deposited in metered amounts on a substrate. The printer includes a wheel rotatable by a shaft of a motor, an idler disposed in a paint reservoir, and a segment of wire disposed around the wheel and the idler. A computer controls movement of the wire by controlling the rotation of the wheel. As the motor rotates the wheel, conductive ink contained within the paint reservoir coats the wire and is drawn by the wire in front of an air stream, which pulls the conductive ink from the wire and carries it toward the substrate. The digital printing of conductive ink can be used to form conductive patterns, such as circuit elements, on the substrate.

### BACKGROUND

Two conventional printing techniques include ink jet printing and screen printing. Ink jet printers work by depositing small droplets of ink in various colors, typically cyan, magenta, yellow and black, on a print medium or substrate to form a color image. Conventional thermal ink jet printing heads include several nozzles and thermal elements. Ink is expelled from the nozzles in a jet by bubble pressure created by heating the ink using the thermal elements while the nozzles and thermal elements are in close proximity. Ink jet print heads use relatively small orifices, valves, and nozzles for depositing the desired quantity and color of ink on the print medium. Therefore, very fine grade inks are required in which particle sizes of the pigments within the inks are kept to a minimum to help keep the orifices, valves, and nozzles of the ink system from becoming clogged.

In screen printing, ink is forced through a design-bearing screen onto the substrate being printed. The screen is made of a piece of porous, finely woven fabric stretched over a wood or aluminum frame. Areas of the screen are blocked off with a non-permeable material, a stencil, which is a negative of the image to be printed. The screen is placed on top of a piece of print substrate, often paper or fabric. Ink is placed on top of the screen, and scraper blade is used to push the ink evenly into the screen openings and onto the substrate. The ink passes through the open spaces in the screen onto the print substrate; then the screen is lifted away. The screen can be re-used for multiple copies of the image, and cleaned for later use. If more than one color is being printed on the same surface, the ink is allowed to dry and then the process is repeated with another screen and different color of ink. Screen printing requires use of inks having a relatively high viscosity to prevent all the ink from simply passing through the screen onto the print substrate.

Due to their particular rheological and particulate size requirements, neither ink jet printing nor screen printing are suitable for use in printing some conductive inks such as filled materials, carbon nanotubes, carbon nanowires, metal nanowires, and transparent conductors. In particular, the large particle size of certain conductive materials makes them unsuitable for ink jet printing, and the low viscosity of certain conductive materials makes them unsuitable for screen printing.

Accordingly, a need exists for an apparatus and method for printing conductive materials.

### SUMMARY

A method, consistent with the present invention, can be used to form a conductive pattern on a substrate. The method includes coating at least a portion of an exterior surface of a cable with a conductive ink, directing an air stream at the portion of the cable coated with the conductive ink, and electronically controlling advancement and position of the cable through the air stream such that a metered amount of the conductive ink is removed from the exterior surface of the cable and is deposited onto the substrate to form a conductive pattern on the substrate.

An apparatus, consistent with the present invention, can deposit a conductive ink on a substrate. The apparatus includes an electronically controllable drive mechanism and a structure associated with the drive mechanism and movable thereby. A conductive ink supply is in communication with the structure for depositing conductive ink on at least a portion of the structure. At least one fluid nozzle having at least one nozzle orifice is positioned and oriented for directing at least one jet of fluid toward at least a portion of the structure to remove an amount of the conductive ink from the structure and direct the amount toward a substrate. The movement of the structure relative to the at least one fluid nozzle substantially controls the amount of the conductive ink removed from the structure, and the amount of the conductive ink directed to the substrate form a conductive pattern on the substrate.

### BRIEF DESCRIPTION OF THE DRAWINGS

The accompanying drawings are incorporated in and constitute a part of this specification and, together with the description, explain the advantages and principles of the invention. In the drawings,

FIG. 1 is a perspective view of one embodiment of a fluid delivery system or printer;

FIG. 2 is a side view of the fluid delivery system of FIG. 1;

FIG. 3 is a diagram of a system to use the printer to print conductive materials onto a substrate;

FIG. 4 is a photograph of an RF antenna printed with the printer;

FIG. 5 is a diagram of an experimental system to test the printed RF antenna shown in FIG. 4;

FIG. 6 is a graph of a frequency response of the experimental system with and without the RF antenna shown in FIG. 4;

FIG. 7 is a graph of the difference between the experimental system measurement with and without the RF antenna shown in FIG. 4;

FIG. 8 is a photograph of RF antennas printed on a cloth using the printer; and

FIGS. 9a and 9b are photographs of an RF antenna printed on two sides of a cloth using the printer and connected through the cloth by a via.

### DETAILED DESCRIPTION

### Printing System

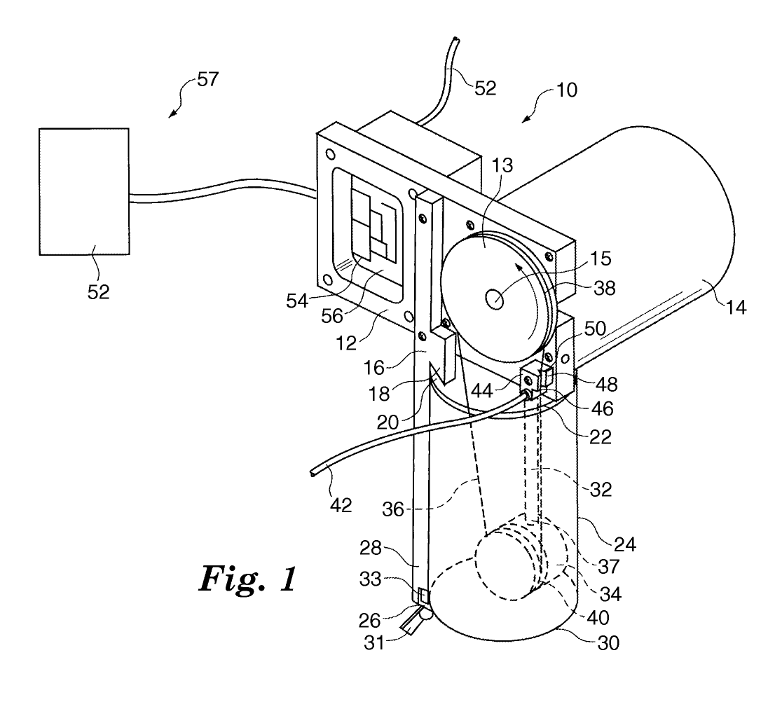

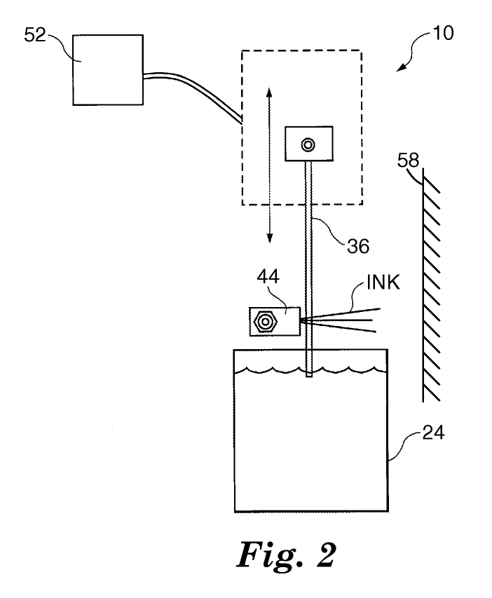

FIG. 1 is a perspective view of one embodiment of the fluid delivery system or printer, generally indicated at 10. FIG. 2 is a side view of the fluid delivery system or printer of FIG. 1. A pulley 13 having a circumscribing groove 38 defined therein is secured to a shaft 15 of a motor 14. An elongate frame member 32 is secured to frame or plate 12 and extends into a reservoir of ink 24. A rotatable or stationary guide 34 is attached to a distal end 37 of elongate frame member 32. Guide 34 is illustrated as a cylindrical, non-rotatable member having a groove 40 circumscribing guide 34 in which a wire cable 36 can slide during rotation of wheel 13. Alternatively, guide 34 can be implemented with a rotatable member. As used herein, the term “cable” or “wire” or “wire cable” or “elongate segment” is meant to include the use of a wire, a cable formed of multiple wires, a rod, a saw tooth wheel, or variations thereof. Wire cable 36 is disposed in groove 38 circumscribing the wheel 13 and in groove 40 circumscribing guide 34.

An elongate reservoir retaining member 16 is attached to plate 12 and includes a flange 18 defining a notch 20 between the flange 18 and elongate reservoir retaining member 16. Notch 20 is configured to receive a top lip 22 of ink reservoir 24. A bottom plate 26 is secured to a distal end 28 of elongate reservoir retaining member 16 with a threaded nut 31 that is threaded onto a threaded shaft 33. Threaded shaft 33 is secured to distal end 28 of elongate reservoir retaining member 16. Bottom plate 26 abuts against the bottom 30 of ink reservoir 24 and holds it between flange 18 and bottom plate 26.

An air supply hose 42 is secured to a nozzle body 44 and supplies air through a nozzle orifice 46 that is aimed at a portion of cable 36. A cable guide 48 defining a longitudinal slot 50 is positioned proximate nozzle orifice 46. Cable 36 rides within slot 50 and is thus held in relative position to nozzle orifice 46 so that air passing therethrough does not substantially move cable 36 from in front of nozzle orifice 46 or cause cable 36 to substantially vibrate. Slot 50 can alternatively include a small rotatable guide.

Rotation of shaft 15 may be controlled by a controller, generally indicated at 57. Any type of controller may be used. In one embodiment, the controller includes circuitry 54 in a module 56 that receives signals from a signal generating device 52, such as a microprocessor or other devices that can supply discrete signals to instruct selective rotation of the shaft 15 of the motor. Circuitry 54 receives a signal(s) from generating device 52 and rotates shaft 15 of the motor according to the signal(s).

In operation, ink contained in reservoir 24 is picked up by wire cable 36 and advanced by rotation of wheel 13, indicated by the arrow, in front of nozzle orifice 46. Fluid that is blown through nozzle orifice 46 disperses or pulls the ink from cable 36 toward the print medium. Depending on the viscosity of the ink in the reservoir, the cross-sectional diameter of cable 36, and the diameter of wheel 13, a relatively precise amount of ink can be dispensed. The ink is dispersed onto a substrate 58, as illustrated in FIG. 2. Further, because the ink to be dispensed does not pass through an orifice, the printer is particularly well suited for printing of filled materials with a wide range of viscosities used as conductive inks.

The print head in system 10 can include alternative implementations, as shown in FIG. 1A in U.S. Pat. No. 5,944,893 and described in the corresponding text. For example, the print head can include a discontinuous wire, guide 34 can be rotatable, a spring tensioning mechanism can be used, and an air solenoid can be used to turn the air supply on and off.

The fluid delivery system or printer of the present invention is based on printer technology that is described in U.S. Pat. Nos. 5,944,893; 5,972,111; 6,089,160; 6,090,445; 6,190,454; 6,319,555; 6,398,869; and 6,786,971, all of which are incorporated herein by reference.

As used herein, the term “ink” is meant to include any pigmented material, including, but not limited to, inks, dyes, paints, or other similarly pigmented liquids.

As used herein, the term “print medium” or “substrate” are meant to include any print medium known in the art, including but not limited to paper, plastic, polymer, synthetic paper, non-woven materials, cloth, metal foil, vinyl, films, glass, wood, cement, and combinations or variations thereof. The print medium or substrate can be a rigid material or a flexible material.

### Printing of Conductive Inks

Embodiments of the present invention include methods to digitally print electrically conductive lines or patterns using conductive inks and the printer described above. The printer is especially suited to digitally printing electrically conductive inks that cannot be digitally printed using other techniques. As described above, the printer uses a wire to carry liquid from the paint container to the air jet, which blows the liquid off the wire and onto the surface being coated. The quantity and quality of paint applied to the surface depends on the wire feed rate, rheologic properties of the fluid, air flow, orifice geometry, and distance from the print head to the surface, among other things. The mechanism for this paint transport is shown in FIGS. 1 and 2.

The printer is uniquely qualified to print electrically conductive inks that are highly filled, or inks that have large particles due to the fact, among other things, that the ink does not pass through a closed orifice. In particular, the printer can print inks that have a viscosity too low for conventional screen printing and can print inks that have a viscosity too high for conventional ink jet printing. In addition, the printer can print inks that have a particle size too great for both conventional ink jet printing or screen printing. The maximum viscosity of an ink for ink jet printing is typically 20 cP, and the maximum particle size for ink jet ink printing is typically 1-2 microns. Screen print inks typically require a viscosity greater than 800 cP, and screen printing can typically print inks with particle sizes up to 125 microns. In comparison, the printer can print inks having a viscosity between 20 cP and 800 cP, in addition to having the capability to prints inks having a viscosity less than 20 cP and greater than 800 cP. For example, the printer can print inks having a viscosity between 1 cP and 20 cP. Also, the printer can print inks having a particle size greater than 125 microns, in addition to having the ability to print inks having a particle size less than 125 microns. For example, the printer can print inks having a particle size greater than 1 micron.

The type of conductive inks that can be printed using the printer includes but is not limited to the following examples: metal flake paints, metal inks, metal oxide particles used to fill inks, conductive polymers, conductive epoxies, carbon inks, carbon nanotube inks, metal and metal oxide nanowire suspensions, metal nanowires, semiconductive inks, and other inks and paints. Examples of metals that can be used to fill inks includes but is not limited to flakes or particles of the following: gold, silver, platinum, palladium, aluminum, titanium, chromium, copper, nickel, tantalum, vanadium, tungsten, tin, molybdenum, and zinc. Other filled materials can use non-metallic conductive particles. The printer can also be used to print transparent conductors, examples of which include but are not limited to nanoparticulate conductors, indium tin oxide (ITO), fluorine tin oxide (FTO), antimony tin oxide (ATO), zinc oxide (ZnO), aluminum doped zinc oxide (AZO) and other transparent conducting oxides (TCO). Conductive inks also include members of the class of inks that become electrically conductive in a post-printing treatment including but not limited to ultraviolet (UV) curing, heating, sintering, plasma treating, corona treating, or chemically reacting. Therefore the term “conductive ink” is intended to include inks that are electrically conductive at the time of printing or inks that become electrically conductive after printing through a post-printing treatment. In addition, the conductive inks may include materials that modify the physical or mechanical properties of the inks. These materials may include but are not limited to the following: surfactants, polymers, surface active materials, UV curing agents, actinic radiation curing agents, thermoplastics, binders, and wetting agents.

Conductive patterns include any type of conductive pattern in any configuration. For example, conductive patterns can be printed with the printer to form the following: circuit elements including but not limited to transistors, capacitors, resistors, inductors, jumpers, electrodes, and connectors; bus bars; touch panels; thin film transistors for display backplanes; touch panels; solar panels; traffic signs with circuits; and display devices.

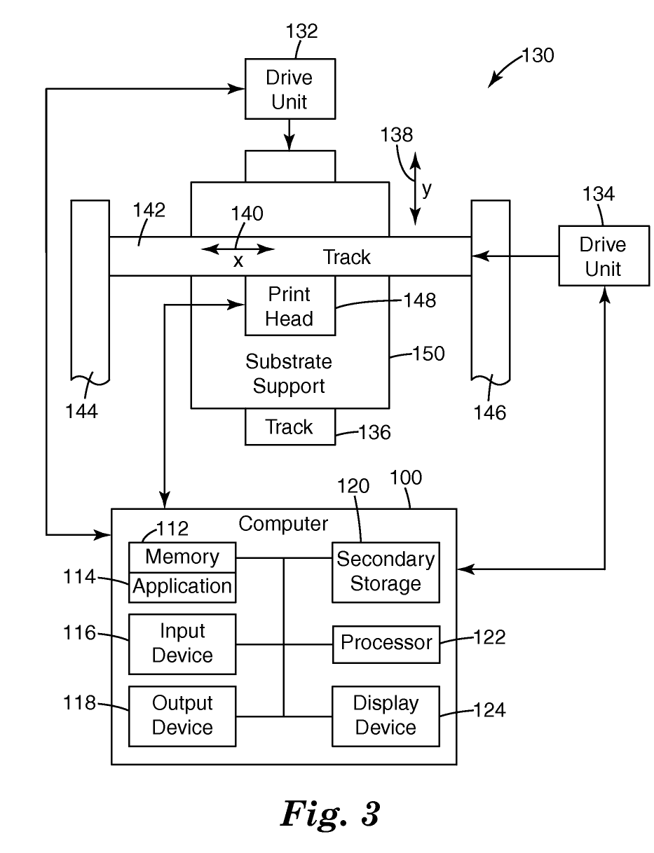

FIG. 3 is a diagram of a system 130 to use the printer to print conductive materials onto a substrate. System 130 includes a print head 148 mounted on a track 142 supported by vertical posts 144 and 146, a wall, or other support. Print head 148 corresponds with printing system 10. A drive unit 134, using a motor, controls movement of print head 148 along track 142 in an x-direction as indicated by arrows 140. A substrate support 150 is located on a track 136, which would be supported by a vertical post, wall, or other support. A drive unit 132, using a motor, controls movement of substrate support 150 along track 136 in a y-direction as indicated by arrows 138. A substrate can be mounted or otherwise affixed to substrate support 150, and a conductive line or pattern can be printed upon the substrate by print head 148. The configuration of the conductive line or pattern is determined by the coordinated movement of print head 148 along track 142 and the substrate on substrate support 150 along track 136.

A computer 100, corresponding with controller 57 and used to implement controller 57, electronically controls print head 148 and drive units 132 and 134 for moving substrate support 150 and print head 148, respectively. Computer 100 can include, for example, the following components: a memory 112 storing one or more applications 114; a secondary storage 120 for providing non-volatile storage of information; an input device 116 for entering information or commands into computer 100; a processor 122 for executing applications stored in memory 112 or secondary storage 120, or as received from another source; an output device 118 for outputting information, such as information provided in hard copy or audio form; and a display device 124 for displaying information in visual or audiovisual form. Computer 100 can optionally include a connection to a network such as the Internet, an intranet, or other type of network.

Computer 100 can be programmed to control movement of print head 148 along track 142 and substrate support 150 along track 136. In particular, computer 100 can be programmed to electronically control movement of print head 148, via drive unit 134, in x-direction 140 laterally across a substrate on substrate support 150, and computer 100 can be programmed to electronically control movement of the substrate on substrate support 150, via drive unit 132, in y-direction 138 vertically with respect to print head 148. Computer 100 also controls print head 148, as described above, for movement of the wire and delivery of the conductive ink from the wire to the substrate. Computer 100 can also be programmed to control an air solenoid in system 10. The use of tracks 136 and 142 for coordinated movement of substrate support 150 and print head 148, respectively, thus effectively functions as an X-Y stage for using the printer to print a wide variety of shapes and configurations of conductive patterns, lines, or other elements. As an alternative, conductive lines or patterns can be printed using one of the following techniques: coordinated movement of print head 148 in the y-direction and substrate support 150 in the x-direction; movement of print head 148 in both the x-direction and y-direction; or movement of substrate support 150 in both the x-direction and y-direction.

Computer 100 can also be programmed to control the printer for radial printing. In particular, a first orifice can direct an air jet at the wheel or wire to remove paint in a purely radial direction, while other orifices supplying air can be angled above the air jet created by the first orifice to help eliminate conical divergence of the paint as it is pulled from the surfaces of the wheel or wire.

### EXAMPLES

### Example 1

Conductive liquid silver ink (PELCO colloidal silver, part #16034, Ted Pella Inc.) was diluted with a 50/50 mixture of toluene and isopropyl alcohol. The ink was diluted simply to increase the volume of the sample. The ink was added to the small container in the print head. The print head used to print conductive ink for the examples refers to a print head consistent with the print head in the printer described above with the alternative features as identified above with respect to the print head shown in FIG. 1A in U.S. Pat. No. 5,944,893. The ink was printed on a polyethylene napthalate substrate with the conditions set forth in Table 1.

The term “standoff” used in the examples describes the distance between the wire on the print head and the print medium. The “air pressure” refers to the regulated air pressure applied to the orifice block. The term “shim thickness” refers to the size of the shim placed between the two halves of the doctor blade. The shim determines the gap between the edges of the doctor blade and the wire. The terms “paint velocity”, “paint acceleration”, and “paint deceleration” refer to the velocity, acceleration, and deceleration parameters of the program controlling the motor.

The print program “Large square vertical lines.txt” used in the examples refers to instructions executed by computer 100 to control system 130 to print lines on a substrate. Computer 100 can be programmed to cause the coordinated movement of print head 148 and a substrate on substrate support 150, along with control of print head 148, to print lines of any particular shape and length. Also, computer 100 can be programmed to repeat the same pattern (passes) of depositing conductive ink on the substrate to increase an amount of conductive ink forming the lines.

Each printed line is approximately 4.5 inches long and 0.11 inches wide. The conductivity of the lines was measured with an HP 34401A multimeter using a two point probe across the entire length of the lines. The resistance of the lines ranged from 2100Ω to about 500Ω. The measurements for each line are provided in Table 2.

TABLE 1
Coating and Paint Parameters

| Formulation | F-082406-001 |
|---|---|
| Air pressure | 20 PSI |
| Standoff | 0.2 inches |
| Paint program | Large square vertical lines.txt |
| Wire diameter | 8 mil |
| Shim thickness | 10 mil |
| Paint velocity | 15.7 inches/second (in/s) |
| Paint acceleration/deceleration | 47.1 in/s² |
| Passes | 100 |

TABLE 2

| Line | Resistivity |
|---|---|
| 1 | 0.10 kΩ |
| 2 | 0.11 kΩ |
| 3 | 0.12 kΩ |
| 4 | 0.17 kΩ |
| 5 | 0.16 kΩ |
| 6 | 0.15 kΩ |
| 7 | 0.21 kΩ |
| 8 | 0.5 kΩ |
| 9 | 2.1 kΩ |

### Example 2

Carbon nanotube (CNT) ink was created by adding 50 mg single wall carbon nanotubes (Aldrich, cat #636797-1G) and 500 mg sodium dodecyl sulfate (Aldrich, cat #86201-0) to 50 ml deionized water. This solution was sonicated for 15 minutes at 50% duty cycle with a sonic horn. The ink was added to the small container in the print head. The ink was printed on an polyimide substrate, previously patterned with two electrodes spaced 1.5 inches apart. The substrate was attached to a heater block held around 130° C. The ink was printed with the conditions set forth in Table 3. The printed line is approximately 1.5 inches long and 0.18 inches wide. The conductivity of the line was measured with an HP 34401A multimeter using a two point probe across the entire length of the lines. The resistance of the line was 5.73 kΩ.

TABLE 3
Coating and Paint Parameters

| Formulation | 50 ml water, 500 mg SDS, |
|---|---|
| | 50 mg SWCNT |
| Air pressure | 26 psi |
| Standoff | 0.5 inches |
| Paint program | Large square vertical lines.txt |
| Wire diameter | 8 mil |
| Shim thickness | 10 mil |
| Paint velocity | 15.7 in/s |
| Paint acceleration/deceleration | 47.1 in/s² |
| Passes | 100 |

### Example 3

In this example, a radio frequency (RF) antenna 160 shown in the photograph in FIG. 4, similar in shape to an RFID antenna, was printed on a substrate 162 with the printer described above. The printed line forming RF antenna 160 is approximately 0.10 inches wide. Tables 4 and 5 list, respectively, the coating parameters and paint parameters used to print antenna 160 with the printer. The conductivity of the line forming the RF antenna 160 was measured with an HP 34401A multimeter using a two point probe across the entire length of the lines. Table 4 lists the resistivity of the line forming antenna 160. A resonant circuit was formed with the antenna 160 by connecting a 150 pF capacitor 168 to the ends 164 and 166 of the antenna.

The print program “RFID.txt” used in the examples refers to instructions executed by computer 100 to control system 130 to print an RF antenna on a substrate using the corresponding coating parameters and paint parameters. Computer 100 can be programmed to cause the coordinated movement of print head 148 and a substrate on substrate support 150, along with control of print head 148, to print lines forming the RF antennas. Also, computer 100 can be programmed to repeat the same pattern (passes) of depositing conductive ink on the substrate to increase an amount of conductive ink forming the lines for each of the RF antennas.

The paint formulation “F-082406-001” used in this example refers to silver paint 15 g, part number P-CS-15, from Energy Beam Sciences, East Granby, Conn., U.S.A.

The orifice design OP-001 used in the examples refers to a three-hole orifice in a substantially equilateral triangular configuration in which a center hole at the top point of the triangular shape has a diameter of 0.023 inches and the lower holes at the bottom two points of the triangular shape each have a diameter of 0.02 inches.

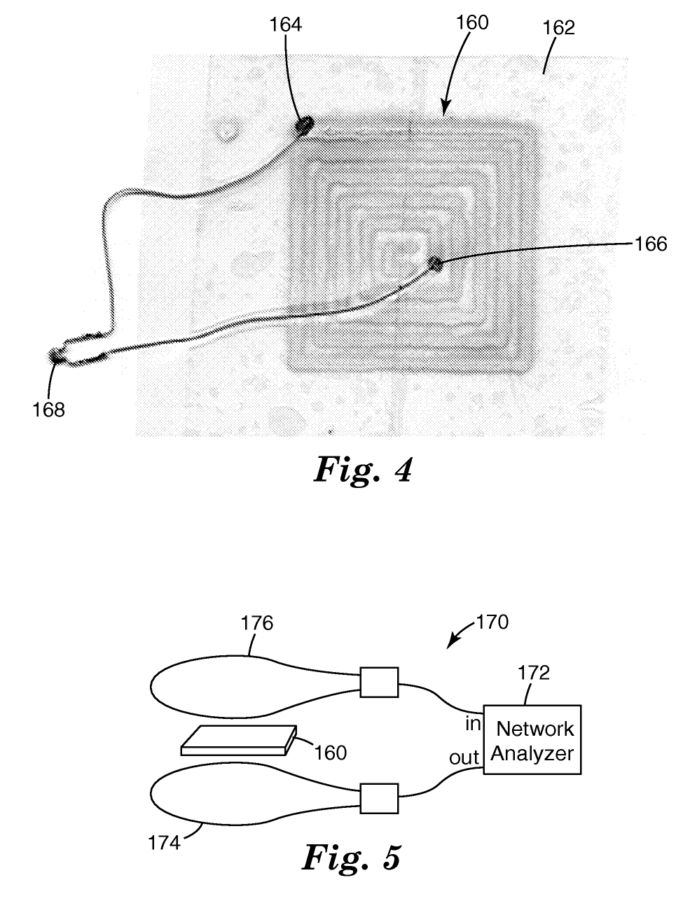

FIG. 5 is a diagram of an experimental system 170 used to test the frequency response of antenna 160. System 170 includes a network analyzer 172 connected to a source loop 174 and a measurement loop 176. The RF antenna 160 was placed between source loop 174 and measurement loop 176 during the test. To measure the frequency response, network analyzer 172 was run in transmission mode using a 10 kHz to 30 MHz scan, and within the scan range 1601 magnitude spectrum points were obtained from measurement loop 176.

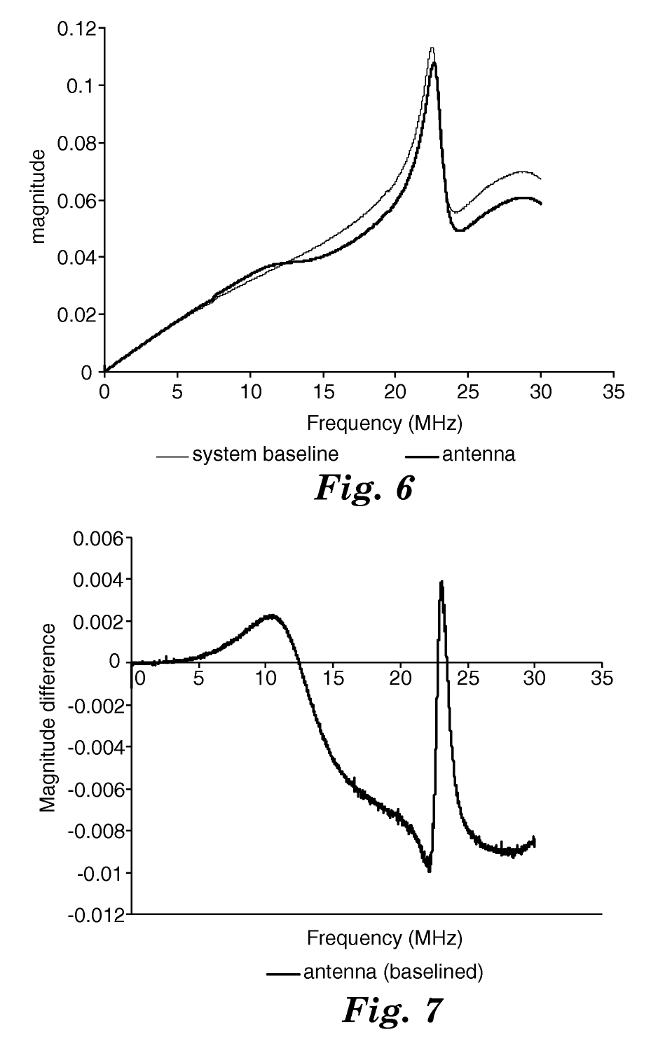

FIG. 6 is a graph of the frequency response of the experimental system with and without the RF antenna 160. FIG. 7 is a graph of the difference between the experimental system measurement with and without the RF antenna 160. As represented in FIGS. 6 and 7, the RF antenna was measured to have a resonance frequency of 12.55 MHz.

TABLE 4
Coating Parameters

| Coating Parameter | Data |
|---|---|
| Work type | Conductive materials |
| Paint formulation | F-102606-001 |
| Viscosity | Unknown |
| Substrate | 2 mil PET |
| Air pressure | 14 psi |
| Standoff (can to substrate) | 0.20 inches |
| Print program | RFID.txt |
| Wire diameter | 8 mil |
| Shim thickness | 10 mil |
| Orifice design | OP-001 |
| Doctor blade to orifice distance | 0.120 inches |
| Orifice to wire distance | 0.19 inches |
| Paint velocity | 6.28 in/s |
| Paint acceleration | 157 in/s² |
| Paint deceleration | 157 in/s² |
| Line resistivity | R = ~37 Ω |

TABLE 5
Paint Parameters

| Paint Parameter | Data |
|---|---|
| Paint ID# | F-102606-001 |
| Color type | Colloidal silver |
| Color amount | 75 grams |
| IPA (mL) | Negligible |
| Other (mL) | Negligible |
| Viscosity (cP) | Not tested |

### Example 4

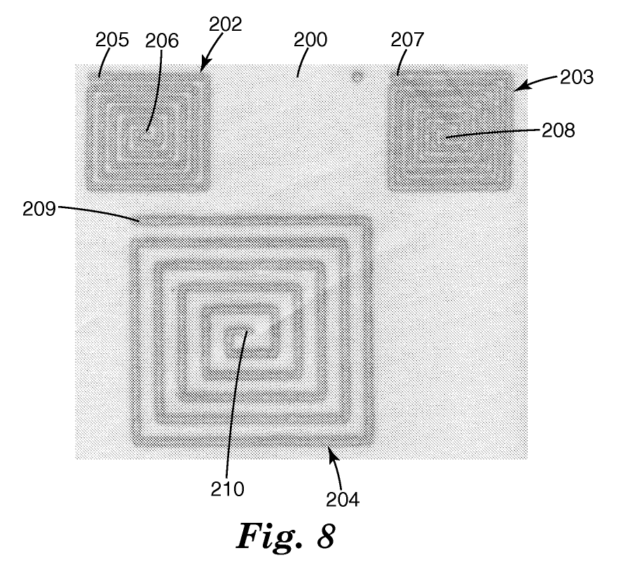

In this example, three RF antennas 202, 203, and 204 shown in the photograph in FIG. 8 were printed on a cloth substrate 200 with the printer described above. The cloth substrate used was artists' canvas, a flexible material. The printed lines forming RF antennas 202, 203, and 204 are each approximately 0.11 inches wide. The conductivity of the lines forming the RF antennas 202, 203, and 204 was measured with an HP 34401A multimeter using a two point probe across the entire length of the lines from their end points. In particular, the conductivity of antenna 202 was measured from ends 205 and 206, the conductivity of antenna 203 was measured from ends 207 and 208, and the conductivity of antenna 204 was measured from ends 209 and 210. Tables 6 and 7 list, respectively, the coating parameters and paint parameters used to print antennas 202, 203, and 204 with the printer. Table 6 also lists the resistivity of the lines forming antennas 202, 203, and 204.

TABLE 6
Coating Parameters

| Coating Parameter | Data | Data | Data |
|---|---|---|---|
| Identification no. | Sample 1 (202) | Sample 2 (203) | Sample 3 (204) |
| Work type | Conductive | Conductive | Conductive |
| | materials | materials | materials |
| Paint formulation | F-102606-001 | F-102606-001 | F-102606-001 |
| Viscosity | Unknown | Unknown | Unknown |
| Substrate | Cloth | Cloth | Cloth |
| Air pressure | 14 psi | 14 psi | 14 psi |
| Standoff (can to | 0.25 inches | 0.25 inches | 0.25 inches |
| substrate) | | | |
| Print program | RFID.txt | RFID.txt | RFID.txt |
| Wire diameter | 8 mil | 8 mil | 8 mil |
| Shim thickness | 10 mil | 10 mil | 10 mil |
| Orifice design | OP-001 | OP-001 | OP-001 |
| Doctor blade to orifice | 0.120 inches | 0.120 inches | 0.120 inches |
| distance | | | |
| Orifice to wire | 0.19 inches | 0.19 inches | 0.19 inches |
| distance | | | |
| Paint velocity | 6.28 in/s | 6.28 in/s | 6.28 in/s |
| Paint acceleration | 157 in/s² | 157 in/s² | 157 in/s² |
| Paint deceleration | 157 in/s² | 157 in/s² | 157 in/s² |
| Wire multiple | 5 | 5 | 5 |
| Number of passes | 4 | 6 | 8 |
| Line resistivity | 10 kΩ | 5 kΩ | 810 Ω |

TABLE 7
Paint Parameters

| Paint Parameter | Data |
|---|---|
| Paint ID# | F-102606-001 |
| Color type | Colloidal Silver Liquid |
| Color amount (g) | 75 |
| IPA (mL) | Negligible |
| Toluene (mL) | Negligible |
| Comments | Small amounts of solvent were used to clean |
| | out the jars. |

### Example 5

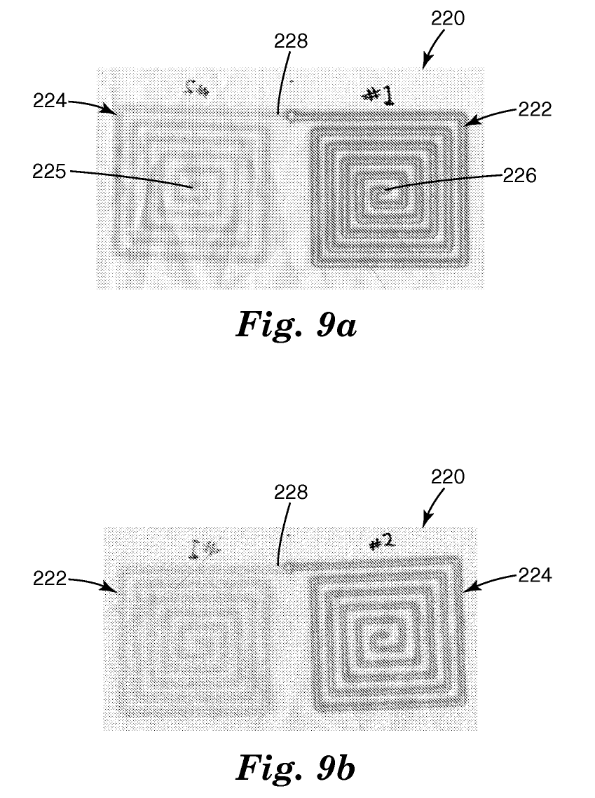

In this example, two RF antennas 222 and 224 as shown in the photographs in FIGS. 9a and 9b were printed on two sides of a cloth substrate 220 and connected through the cloth by a via 228. The cloth substrate used was artists' canvas, a flexible material. The printed lines forming RF antennas 222 and 224 are each approximately 0.11 inches wide. The via 228 was formed by the conductive ink penetrating the cloth sufficiently to electrically connect antennas 222 and 224. The conductivity of the lines forming the RF antennas 222 and 224 was measured with an HP 34401A multimeter using a two point probe across the entire length of the lines at ends 225 and 226. Tables 8 and 9 list, respectively, the coating parameters and paint parameters used to print antennas 222 and 224 with the printer. Table 8 also lists the resistivity of the lines forming antennas 222 and 224.

TABLE 8
Coating Parameters

| Coating Parameter | Data |
|---|---|
| Identification no. | Sample 4 (222, 224) |
| Work type | Conductive materials |
| Paint formulation | F-102606-001 |
| Viscosity | Unknown |
| Substrate | Cloth |
| Air pressure | 14 psi |
| Standoff (can to substrate) | 0.25 inches |
| Print program | RFID.txt |
| Wire diameter | 8 mil |
| Shim thickness | 10 mil |
| Orifice design | OP-001 |
| Doctor blade to orifice distance | 0.120 inches |
| Orifice to wire distance | 0.19 inches |
| Paint velocity | 6.28 in/s |
| Paint acceleration | 157 in/s² |
| Paint deceleration | 157 in/s² |
| Wire multiple | 5 |
| Number of passes | 8 |
| Line resistivity | 500 Ω |

TABLE 9
Paint Parameters

| Paint Parameter | Data |
|---|---|
| Paint ID# | F-102606-001 |
| Color type | Colloidal Silver Liquid |
| Color amount (g) | 75 |
| IPA (mL) | Negligible |
| Toluene (mL) | Negligible |
| Comments | Small amounts of solvent were used to clean |
| | out the jars. |

1. A method of forming a conductive pattern on a substrate, comprising:
coating at least a portion of an exterior surface of a cable with a conductive ink;
directing an air stream at the at least a portion of the cable coated with the conductive ink; and
electronically controlling advancement of the cable through the air stream such that a metered amount of the conductive ink is removed from the exterior surface of the cable and is deposited onto the substrate to form a conductive pattern on the substrate.

2. The method of claim 1, wherein the conductive ink has a viscosity between 20 cP and 800 cP.

3. The method of claim 1, wherein the conductive ink has a viscosity between 1 cp and 20 cP

4. The method of claim 1, wherein the conductive ink has a viscosity greater than 800 cP.

5. The method of claim 1, wherein the conductive ink includes conductive particles having a size greater than 125 microns.

6. The method of claim 3, wherein the conductive ink includes conductive particles having a size greater than 1 micron.

7. The method of claim 1, wherein the conductive pattern has a resistivity of less than or equal to 2100Ω.

8. The method of claim 1, wherein the conductive pattern has a resistivity of less than or equal to 500Ω.

9. The method of claim 1, wherein the conductive patterns are transparent conductive patterns.

10. The method of claim 1, wherein the conductive pattern forms an RF antenna.

11. The method of claim 1, wherein the RF antenna is formed on a flexible substrate.

12. The method of claim 11, wherein the RF antenna is formed on both sides of the flexible substrate and connected through the substrate by a via.

13. The method of claim 1, wherein the conductive ink comprises a filled material having metallic particles.

14. The method of claim 1, wherein the conductive ink comprises a filled material having metal oxide particles.

15. The method of claim 1, wherein the conductive ink comprises a filled material having non-metallic particles

16. The method of claim 1, wherein the conductive ink comprises a conductive polymer.

17. The method of claim 1, wherein the conductive ink comprises metal nanowires.

18. The method of claim 1, wherein the conductive ink comprises metal oxide nanowires.

19. The method of claim 1, wherein the conductive ink includes a binder.

20. A method of digital printing to form a conductive pattern on a substrate, comprising:
providing at least one paint injector, the at least one paint injector having a wheel rotatable by a shaft of a motor, an idler at least partially disposed in conductive ink contained in a reservoir, and a wire-like member disposed at least partially around the wheel and the idler;
advancing the wire-like member with the motor to apply a coating of the conductive ink to the wire-like member;
electronically controlling the position of the at least one paint injector relative to the surface and electronically controlling advancement of the wire-like member through the fluid stream; and
directing the fluid stream at the coated portion of the wire-like member, while controlling the position of the paint injector and the advancement of the wire-like member, thereby removing at least a portion of the conductive ink from an exterior of the wire-like member and depositing it onto a substrate to form a conductive pattern on the substrate.

21. An apparatus for digitally printing a conductive pattern on a substrate, comprising:
a support structure;
a carriage associated with and movable in at least one direction relative to the support structure;
an ink injector secured to the carriage, the ink injector comprising:
a motor having a rotatable shaft;
a wheel rotatable by the shaft of the motor;
an idler; and
an elongate segment disposed around at least a portion of the wheel and a portion of the idler and advanceable by the wheel, the elongate segment having a quantity of conductive ink coated onto at least a portion of the elongate segment;
at least one fluid nozzle positioned and oriented for directing a jet of fluid toward the at least a portion of the elongate segment to remove an amount of the conductive ink from the elongate segment and direct the amount toward a surface of a substrate to form a conductive pattern on the substrate; and
a controller electronically connected to the motor for controlling rotation of the wheel and for controlling the position of the carriage relative to the support structure.

22. An apparatus for forming a conductive pattern on a substrate, comprising:
an electronically controllable drive mechanism;
a structure associated with the drive mechanism and movable thereby;
a conductive ink supply in communication with the structure for depositing conductive ink on at least a portion of the structure; and
at least one fluid nozzle having at least one nozzle orifice positioned and oriented for directing at least one jet of fluid toward at least a portion of the structure to remove an amount of the conductive ink from the structure and direct the amount toward a substrate,
wherein movement of the structure relative to the at least one fluid nozzle substantially controls the amount of the conductive ink removed from the structure, and wherein the amount of the conductive ink directed to the substrate forms a conductive pattern on the substrate.

23. The apparatus of claim 22, wherein the structure comprises a wire.

24. The apparatus of claim 23, further including a biasing device associated with the wire to maintain tension in the wire.

25. The apparatus of claim 23, further including a mechanical metering device in contact with the wire for removing an amount of the conductive ink from the wire before the wire passes in front of the at least one orifice.

26. The apparatus of claim 22, wherein the conductive ink has a viscosity between 20 cP and 800 cP.

27. The apparatus of claim 22, wherein the conductive ink has a viscosity between 1 cp and 20 cP

28. The apparatus of claim 22, wherein the conductive ink has a viscosity greater than 800 cP.

29. The apparatus of claim 22, wherein the conductive ink includes conductive particles having a size greater than 125 microns.

30. The apparatus of claim 27, wherein the conductive ink includes conductive particles having a size greater than 1 micron.

31. The apparatus of claim 22, wherein the conductive pattern has a resistivity of less than or equal to 2100Ω.

32. The apparatus of claim 22, wherein the conductive pattern has a resistivity of less than or equal to 500Ω.

33. The apparatus of claim 22, wherein the conductive patterns are transparent conductive patterns.

34. The apparatus of claim 22, wherein the conductive pattern forms an RF antenna.

35. The apparatus of claim 22, wherein the RF antenna is formed on a flexible substrate.

36. The apparatus of claim 35, wherein the RF antenna is formed on both sides of the flexible substrate and connected through the substrate by a via.

37. The apparatus of claim 22, wherein the conductive ink comprises a filled material having metallic particles.

38. The apparatus of claim 22, wherein the conductive ink comprises a filled material having metal oxide particles.

39. The apparatus of claim 22, wherein the conductive ink comprises a filled material having non-metallic particles

40. The apparatus of claim 22, wherein the conductive ink comprises a conductive polymer.

41. The apparatus of claim 22, wherein the conductive ink comprises metal nanowires.

42. The apparatus of claim 22, wherein the conductive ink comprises metal oxide nanowires.

43. The apparatus of claim 22, wherein the conductive ink includes a binder.
